(19) United States
(12) Patent Application Publication
(10) Pub. No.: US 2026/0137218 A1
(43) Pub. Date: May 21, 2026

(54) CLIP

(71) Applicants: NIFCO INC., Yokosuka-shi (JP); TACHI-S CO., LTD., Tokyo (JP)

(72) Inventors: Masataka KONDO, Kanagawa (JP); Takehiro SATO, Kanagawa (JP); Masanobu MUKUTA, Tokyo (JP); Yousuke NOGUCHI, Tokyo (JP); Ryouta TOMIOKA, Tokyo (JP)

(73) Assignees: NIFCO INC., Yokosuka-shi (JP); TACHI-S CO., LTD., Tokyo (JP)

(21) Appl. No.: 19/378,461

(22) Filed: Nov. 4, 2025

(30) Foreign Application Priority Data
Nov. 19, 2024 (JP) 2024-201241

(51) Int. Cl. A47C 31/02; B60N 2/72

(52) U.S. Cl. CPC A47C 31/023; B60N 2/72

(57) ABSTRACT

A clip has a base portion embedded in a seat body and two locking portions formed on an upper surface of the base portion. The locking portions are arranged longitudinally in a front-rear direction on the upper surface of the base portion, and each locking portion is composed of a pair of locking piece portions extending upward and facing each other. Each locking piece portion has an extension portion connected to the upper surface of the base portion and a claw portion connected to an upper end of the extension portion. One of the locking piece portions is a one-sided locking piece portion, and the other is an elastic locking piece portion. An elastic force of the elastic locking piece portion is smaller than that of the one-sided locking piece portion, and therefore the elastic locking piece portion is more easily elastically deformed than the one-sided locking piece portion.

### BACKGROUND OF THE INVENTION

### 1. Field of the Invention

The present invention relates to a clip for attaching a cover to a seat of, for example, an automobile or the like.

### 2. Description of the Related Art

As a component used when a seat cover is attached to a seat of an automobile or the like, there is a locking tool described in Japanese Patent No. 7275959 (hereinafter, the invention described in Japanese Patent No. 7275959 is referred to as “invention publicly-known in literature 1”). In invention publicly-known in literature 1, the locking tool is embedded in a groove of a urethane seat, and a seat cover is passed through the groove and attached to the locking tool. The locking tool is formed with two locking claw portions arranged longitudinally, and each of the locking claw portions is composed of a pair of locking pieces facing each other. A long locking portion is attached to an underside of the seat cover, and the locking portion is inserted between the locking pieces in a posture parallel to the respective locking pieces and is locked across the respective locking claw portions. Generally, since the locking pieces are made of resin, when the locking portion is inserted between the locking pieces, the locking pieces are elastically deformed in directions away from each other and pushed apart, clamping the locking portion.

### PLT

Patent Literature 1: Japanese Patent No. 7275959

### SUMMARY OF THE INVENTION

However, in invention publicly-known in literature 1, the locking portion of the seat cover may assume a posture that intersects a longitudinal direction of the respective locking claw portions of the locking tool, and in this case, the locking portion may be locked to one locking claw portion but not to the other locking claw portion. Furthermore, if the urethane forming the seat is crushed by a load when the locking portion is pressed against the locking claw portion, the locking tool sinks into the urethane and escapes from the locking portion, which may cause the locking portion to fail to lock into the locking claw portion.

The present invention has been proposed in view of the above circumstances, and an object of the present invention is to provide a clip that can properly attach a seat cover to a seat body. Further, in a broader sense, an object of the present invention is to achieve excellent fuel economy through weight reduction and to address a universal challenge of environmental consideration.

In order to achieve the above objects, a clip according to the present invention is a clip attached to a seat body and configured to attach a seat cover covering the seat body to the seat body by locking a locked portion of the seat cover. The clip includes a base portion embedded in the seat body and a plurality of locking portions arranged longitudinally in a length direction of the locked portion on an upper surface of the base portion and locking the locked portion. The locking portions are each composed of a pair of locking piece portions that extend upward from the upper surface and face each other. The locking piece portions are composed of a one-sided locking piece portion which is one of the locking piece portions, and an elastic locking piece portion which is another of the locking piece portions and is more easily elastically deformed than the one-sided locking piece portion.

According to the clip of the present invention, respective one-sided locking piece portions of the locking portions adjacent to each other may be arranged alternately in a longitudinal direction.

According to the clip of the present invention, in a direction in which the pair of locking piece portions face each other, a thickness of the one-sided locking piece portion may be same as a thickness of the elastic locking piece portion, and in a longitudinal direction, a width of the elastic locking piece portion may be shorter than a width of the one-sided locking piece portion.

According to the clip of the present invention, a height of the elastic locking piece portion may be lower than a height of the one-sided locking piece portion, relative to the base portion.

According to the clip of the present invention, respective elastic locking piece portions of the locking portions adjacent to each other may be arranged alternately in a longitudinal direction.

According to the clip of the present invention, the locking piece portions may each have an extension portion connected to the base portion and a claw portion connected to an upper end of the extension portion.

The clip according to the present invention is attached to a seat body and configured to attach a seat cover covering the seat body to the seat body by locking a locked portion of the seat cover. The clip includes a base portion embedded in the seat body and a plurality of locking portions arranged longitudinally in a length direction of the locked portion on an upper surface of the base portion and locking the locked portion. The locking portions are each composed of a pair of locking piece portions that extend upward from the upper surface and face each other. The locking piece portions are composed of a one-sided locking piece portion which is one of the locking piece portions, and an elastic locking piece portion which is other of the locking piece portions and is more easily elastically deformed than the one-sided locking piece portion. While the locked portion is inserted between the locking piece portions and sandwiched between the one-sided locking piece portion and the elastic locking piece portion, when the locked portion is pressed against the locking piece portions, a posture of the locked portion may be tilted to the locking portion. Even in this case, since the elastic locking piece portion is elastically deformed before the one-sided locking piece portion, the locked portion is inserted between the locking piece portions and is securely locked to the locking portion. Therefore, the seat cover can properly be attached to the seat body.

According to the clip of the present invention, the respective one-sided locking piece portions of the locking portions adjacent to each other may be arranged alternately in a longitudinal direction. When the locked portion is pressed against the locking portion, even if the locked portion may assume a posture that intersects the longitudinal direction of the locking portion, since the respective elastic locking piece portions are elastically deformed before the respective one-sided locking piece portions on both sides of the locked portion, the locked portion is inserted between the locking piece portions and is securely locked to the locking portion. Therefore, the seat cover can properly be attached to the seat body. While the locked portion that comes into contact with the one-sided locking piece portion that is not easily elastically deformed of the pair is pushed toward the elastic locking piece portion by resistance from the one-sided locking piece portion, since the one-sided locking piece portions are arranged alternately, a direction in which the locked portion is pushed is opposite for each locking portion. That is, the locked portion is subjected to a force in a direction that rotates the locked portion from its tilted posture toward a posture along the longitudinal direction, and the locked portion is corrected to the appropriate posture. Therefore, the seat cover can properly be attached to the seat body.

According to the clip of the present invention, in a direction in which the pair of locking piece portions face each other, a thickness of the one-sided locking piece portion may be same as a thickness of the elastic locking piece portion, and in a longitudinal direction, a width of the elastic locking piece portion may be shorter than a width of the one-sided locking piece portion. The elastic locking piece portion is more easily elastically deformed than the one-sided locking piece portion due to its shorter width. Therefore, the ease of elastic deformation can easily be controlled by adjusting the width. On the other hand, since no adjustment of the thickness is required, dimensional control is easy.

According to the clip of the present invention, a height of the elastic locking piece portion may be lower than a height of the one-sided locking piece portion, relative to the base portion. The locked portion approaching the locking portion from above first comes into contact with the one-sided locking piece portion having the high height, thereby being guided toward the elastic locking piece portion having the low height, and the locked portion is inserted between the locking piece portions and securely locked to the locking portion. Therefore, the seat cover can properly be attached to the seat body.

According to the clip of the present invention, the respective elastic locking piece portions of the locking portions adjacent to each other may be arranged alternately in a longitudinal direction. When the locked portion comes into contact with the one-sided locking piece portion and is guided toward the elastic locking piece portion, since the elastic locking piece portion is certainly elastically deformed before the one-sided locking piece portion, the locked portion is inserted between the locking piece portions and is securely locked to the locking portion. Therefore, the seat cover can properly be attached to the seat body.

According to the clip of the present invention, the locking piece portions may each have an extension portion connected to the base portion and a claw portion connected to an upper end of the extension portions. The claw portion locks the locked portion, thereby securely locking the locked portion to the locking portion. Therefore, the seat cover can properly be attached to the seat body.

### BRIEF DESCRIPTION OF THE DRAWINGS

FIG. 1 is a perspective view of a seat in which a clip according to an embodiment of the present invention is used.

FIG. 2 is a cross-section taken along line II-II in FIG. 1, and is a schematic cross-sectional view of a seat body to which the clip according to the embodiment of the present invention is attached.

FIG. 3 is a perspective view of the clip according to the embodiment of the present invention.

FIG. 4 is a top view of the clip according to the embodiment of the present invention.

FIG. 5 is a front view of the clip according to the embodiment of the present invention.

FIG. 6 is a first explanatory perspective view illustrating a first usage state of the clip according to the embodiment of the present invention.

FIG. 7 is a second explanatory perspective view illustrating a second usage state of the clip according to the embodiment of the present invention.

FIG. 8 is a third explanatory perspective view illustrating a third usage state of the clip according to the embodiment of the present invention.

### DESCRIPTION OF THE PREFERRED EMBODIMENTS

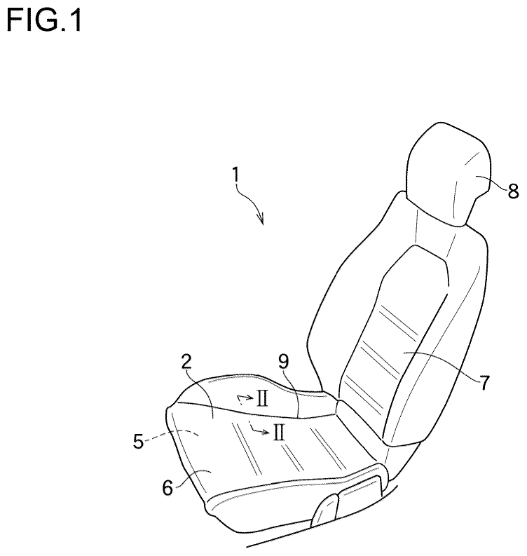

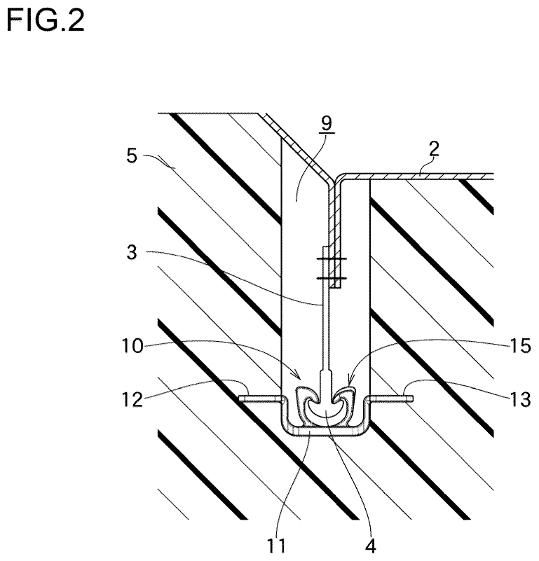

The following is a description of a clip according to an embodiment of the present invention. FIG. 1 illustrates a seat 1 in which a clip 10 according to the present embodiment is used, and FIG. 2 is a partial cross-section of the seat 1 and illustrates a state in which the clip 10 is embedded in the seat 1.

For example, as illustrated in FIG. 1, the clip 10 is used to attach a seat cover 2 to a seat body 5 in the seat 1 of an automobile or the like (not illustrated). The seat 1 is formed by covering the seat body 5 with the seat cover 2 made of leather or the like, and is composed of a seat cushion 6, a seat back 7, a headrest 8, and the like. The seat body 5 is formed by foaming and curing polyurethane raw material or the like, for example, and is molded using a metal forming mold (not illustrated). The seat cover 2 is made of, for example, natural leather, artificial leather, synthetic leather, or the like.

As illustrated in FIG. 2, the seat cover 2 has a hanging cotton cloth 3 sewn to its back side. The hanging cotton cloth 3 is used to attach the seat cover 2 to the seat body 5, and has a locked portion 4 attached to its lower end. The locked portion 4 is clamped to the lower end of the hanging cotton cloth 3 and is a long rod-like member that extends along the lower end of the hanging cotton cloth 3. The locked portion 4 is made of resin, and is produced by extruding polypropylene or the like, for example. The clip 10 is embedded in a groove portion 9 of the seat body 5, and when the seat cover 2 is attached to the seat body 5, the locked portion 4 of the seat cover 2 is locked.

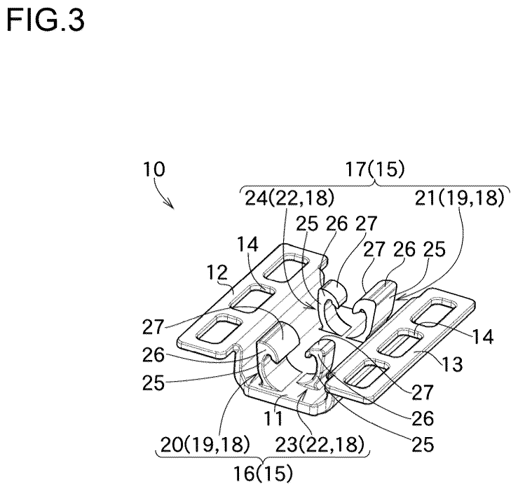

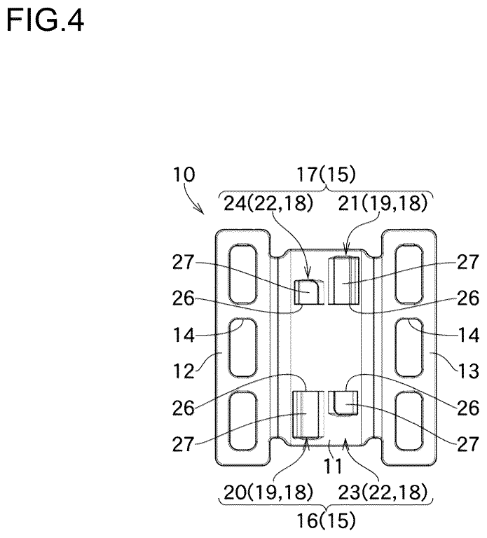

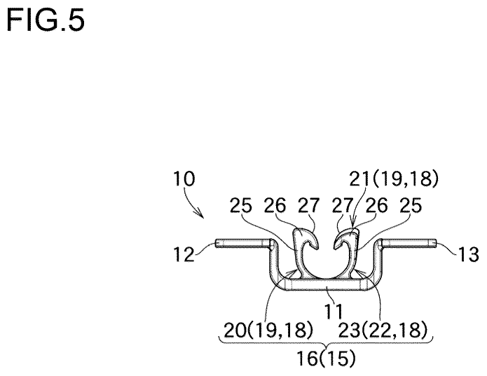

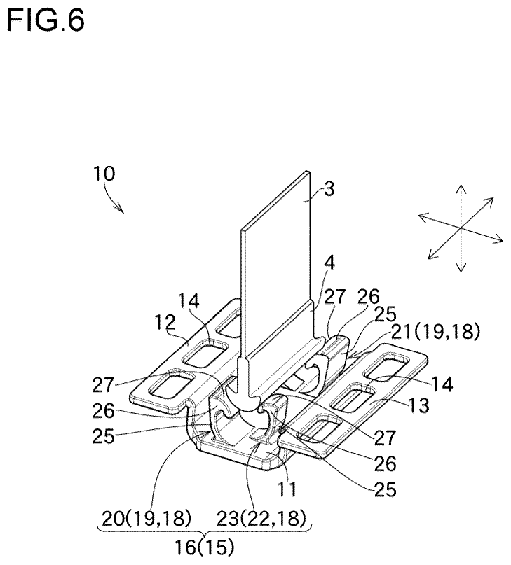

The clip 10 will now be described in detail with reference to the drawings. FIGS. 3 to 5 illustrate an external appearance of the clip 10. In the following description, a length direction of the locked portion 4 (see FIG. 6) is the front or rear, a direction perpendicular to the locked portion 4 is the right side or left side, and a direction in which the locked portion 4 is attached or detached is the up or down.

As illustrated in FIGS. 3 to 5, the clip 10 has a base portion 11 embedded in the seat body 5 and two locking portions 15 formed on an upper surface of the base portion 11. The base portion 11 is in a form of a thin plate and has a generally rectangular shape that is long in the front-rear direction. A right flange portion 12 is connected to a right end of the base portion 11, and a left flange portion 13 is connected to a left end of the base portion 11. Both the flange portions 12 and 13 are generally L-shaped when viewed from the front or rear, and extend upward from the left and right ends of the base portion 11 and then extend laterally to the left and right from their extended tips. A plurality of holes 14 is formed in both the flange portions 12 and 13.

The locking portions 15 are arranged longitudinally in the front-rear direction on the upper surface of the base portion 11. Each of the locking portions 15 is composed of a pair of locking piece portions 18 that extend upward from the upper surface and face each other. Each of the locking piece portions 18 has an extension portion 25 connected to the upper surface of the base portion 11 and a claw portion 26 connected to an upper end of the extension portion 25. The extension portion 25 is curved in a direction that projects laterally. An upper surface portion 27 of the claw portion 26 is curved in a direction that projects upward. Further, the upper surface portion 27 is gradually inclined downward toward the inside. One of the locking piece portions 18 is a one-sided locking piece portion 19, and the other is an elastic locking piece portion 22. An elastic force of the elastic locking piece portion 22 is smaller than an elastic force of the one-sided locking piece portion 19, and therefore, the elastic locking piece portion 22 is more easily elastically deformed than the one-sided locking piece portion 19.

Specifically, a front locking portion 16, which is the locking portion 15 in front, is composed of a front one-sided locking piece portion 20 and a front elastic locking piece portion 23, with the front one-sided locking piece portion 20 being on the right side and the front elastic locking piece portion 23 being on the left side. On the other hand, a rear locking portion 17, which is the locking portion 15 in the rear, is composed of a rear one-sided locking piece portion 21 and a rear elastic locking piece portion 24, with the rear one-sided locking piece portion 21 being on the left side and the rear elastic locking piece portion 24 being on the right side. Therefore, the front one-sided locking piece portion 20 and the rear elastic locking piece portion 24 are adjacent to each other in the front-rear direction, and the front elastic locking piece portion 23 and the rear one-sided locking piece portion 21 are adjacent to each other in the front-rear direction. Thus, the respective one-sided locking piece portions 20 and 21 of the locking portions 15 adjacent to each other in the front-rear direction are arranged alternately in a direction in which the front locking portion 16 and the rear locking portion 17 are arranged longitudinally (in the front-rear direction), and the respective elastic locking piece portions 23 and 24 are also arranged alternately in the front-rear direction.

When a direction in which the one-sided locking piece portion 19 and the elastic locking piece portion 22 face each other (a left-right direction) is taken as a thickness, a thickness of the extension portion 25 of the one-sided locking piece portion 19 and a thickness of the extension portion 25 of the elastic locking piece portion 22 are the same. When the front-rear direction of the locking portion 15 is taken as a width, a width of the extension portion 25 of the elastic locking piece portion 22 is shorter than a width of the extension portion 25 of the one-sided locking piece portion 19. Therefore, the thickness of the extension portion 25 of the front one-sided locking piece portion 20 is the same as the thickness of the extension portion 25 of the front elastic locking piece portion 23, and the thickness of the extension portion 25 of the rear one-sided locking piece portion 21 is the same as the thickness of the extension portion 25 of the rear elastic locking piece portion 24. In addition, the width of the extension portion 25 of the front elastic locking piece portion 23 is shorter than the width of the extension portion 25 of the front one-sided locking piece portion 20, and the width of the extension portion 25 of the rear elastic locking piece portion 24 is shorter than the width of the extension portion 25 of the rear one-sided locking piece portion 21.

A height of the elastic locking piece portion 22 is lower than a height of the one-sided locking piece portion 19, relative to the base portion 11. Therefore, a height of the front elastic locking piece portion 23 is lower than a height of the front one-sided locking piece portion 20, and a height of the rear elastic locking piece portion 24 is lower than a height of the rear one-sided locking piece portion 21.

The clip 10 is configured as described above. Next, a procedure for using the clip 10 will be described together with an operation and effect of the clip 10.

As illustrated in FIG. 2, the clip 10 is embedded in the seat body 5 in advance. Specifically, the clip 10 is placed in advance in a forming mold for the seat body 5 and, for example, polyurethane raw material or the like is poured into the forming mold. When the polyurethane raw material or the like foams, it fills the holes 14 in the right flange portion 12 and the left flange portion 13, and adheres tightly to both the flange portions 12 and 13. The polyurethane raw material or the like cures to fit to both the flange portions 12 and 13, and is firmly fixed to the clip 10. By going through the predetermined process, the seat body 5 is completed with the clip 10 embedded therein. The base portion 11 and both the flange portions 12 and 13 of the clip 10 are embedded in the seat body 5, and the locking portions 15 are exposed in the groove portion 9. The groove portion 9 extends to an upper surface of the seat body 5.

The locked portion 4 of the seat cover 2 is inserted into the groove portion 9 and locked to the locking portion 15. Specifically, as illustrated in FIG. 6, the locked portion 4 is inserted between the locking piece portions 18 and sandwiched between the one-sided locking piece portion 19 and the elastic locking piece portion 22. When the locked portion 4 is pressed against the locking portion 15, the locked portion 4 first comes into contact with the claw portion 26 of the one-sided locking piece portion 19. The locked portion 4 first comes into contact with the one-sided locking piece portion 19 having the high height, slides over the upper surface portion 27 of the claw portion 26, and is guided toward the elastic locking piece portion 22 having the low height. Herein, since the width of the extension portion 25 of the elastic locking piece portion 22 is shorter than the width of the extension portion 25 of the one-sided locking piece portion 19, the elastic locking piece portion 22 is more easily elastically deformed than the one-sided locking piece portion 19 due to its shorter width. Therefore, when the locked portion 4 comes into contact with the claw portion 26 of the elastic locking piece portion 22, the elastic locking piece portion 22 is elastically deformed and spreads out laterally. At this time, the one-sided locking piece portion 19 is not elastically deformed or is elastically deformed slightly compared to the elastic locking piece portion 22. Since a gap between the locking piece portions 18 widens, the locked portion 4 is inserted between the locking piece portions 18 and locked (see FIG. 2). In particular, the claw portions 26 of the one-sided locking piece portion 19 and the elastic locking piece portion 22 lock the locked portion 4, thereby securely locking the locked portion 4 to the locking portion 15.

As described above, the seat cover 2 is properly attached to the seat body 5 by the clip 10. Furthermore, the clip 10 has a structure in which the ease of elastic deformation can easily be controlled by adjusting the widths of the one-sided locking piece portion 19 and the elastic locking piece portion 22. On the other hand, since no adjustment of the thicknesses of the one-sided locking piece portion 19 and the elastic locking piece portion 22 is required, dimensional control is easy.

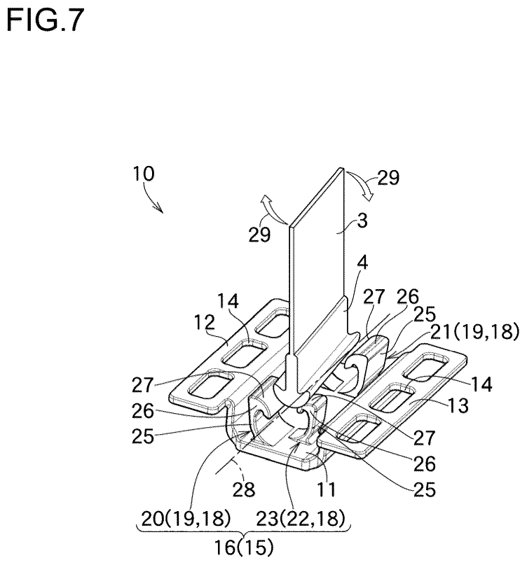

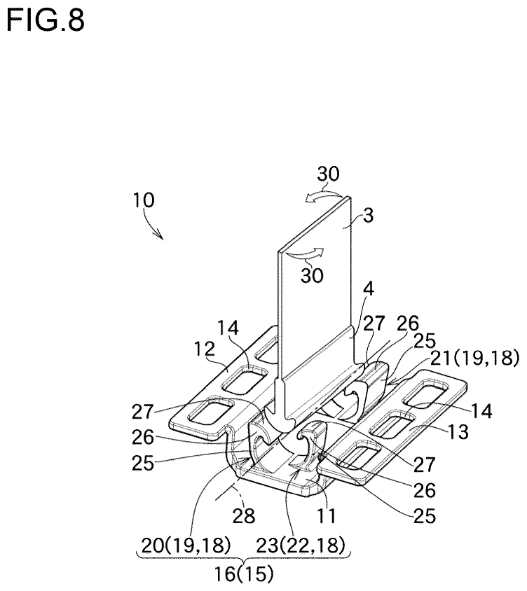

Meanwhile, as illustrated in FIGS. 7 and 8, when the locked portion 4 is pressed against the locking portion 15, a posture of the locked portion 4 may be tilted to the locking portion 15, and the locked portion 4 may assume a posture that intersects the front-rear direction. That is, the locked portion 4 may rotate, with the up-down direction as an axis, in a plane including the front-rear and left-right directions, and may deviate from an imaginary axis 28 in the front-rear direction. Even in this case, since the elastic locking piece portion 22 is easily elastically deformed, the front elastic locking piece portion 23 and the rear elastic locking piece portion 24 are elastically deformed before the front one-sided locking piece portion 20 and the rear one-sided locking piece portion 21 on both sides of the locked portion 4.

For example, as illustrated in FIG. 7, it is assumed that the locked portion 4 rotates with the up-down direction as the axis and deviates counterclockwise from the imaginary axis 28. Since the front elastic locking piece portion 23 and the rear elastic locking piece portion 24 of the front locking portion 16 and the rear locking portion 17 adjacent to each other in the front-rear direction are arranged alternately in the front-rear direction, the front elastic locking piece portion 23 and the rear elastic locking piece portion 24 against which the locked portion 4 is pressed are elastically deformed, and at the same time, due to resistance from the front elastic locking piece portion 23 and the rear elastic locking piece portion 24, the locked portion 4 is subjected to a force in a direction that rotates the locked portion 4, with the up-down direction as the axis, clockwise (see a clockwise rotation direction 29 in FIG. 7) from the tilted posture toward a position along the imaginary axis 28, and the locked portion 4 is corrected to an appropriate posture. Therefore, the seat cover 2 can properly be attached to the seat body 5.

Also, for example, as illustrated in FIG. 8, it is assumed that the locked portion 4 rotates with the up-down direction as the axis and deviates clockwise from the imaginary axis 28. Since the front one-sided locking piece portion 20 and the rear one-sided locking piece portion 21 of the front locking portion 16 and the rear locking portion 17 adjacent to each other in the front-rear direction are arranged alternately in the front-rear direction, the locked portion 4 pressed against the front one-sided locking piece portion 20 and the rear one-sided locking piece portion 21 is pushed toward the front elastic locking piece portion 23 by resistance from the front one-sided locking piece portion 20 and is also pushed toward the rear elastic locking piece portion 24 by resistance from the rear one-sided locking piece portion 21, and thus a direction in which the locked portion 4 is pushed is from right to left in the front locking portion 16 and from left to right in the rear locking portion 17. That is, since the directions in which the locked portion 4 is pushed are opposite to each other in the locking portions 16 and 17, the locked portion 4 is subjected to a force in a direction that rotates the locked portion 4 counterclockwise from its tilted posture toward the posture along the imaginary axis 28 (see a counterclockwise rotation direction 30 in FIG. 8), and the locked portion 4 is corrected to the appropriate posture. Therefore, the seat cover 2 can properly be attached to the seat body 5.

In particular, when the locked portion 4 is pressed against the locking portion 15, the locked portion 4 first comes into contact with the front one-sided locking piece portion 20 and the rear one-sided locking piece portion 21 having the high heights, slides over upper surfaces of the claw portions 26 of both the one-sided locking piece portions 20 and 21, and then is guided toward the front elastic locking piece portion 23 and the rear elastic locking piece portion 24 having the low heights. Since both the elastic locking piece portions 23 and 24 are elastically deformed before both the one-sided locking piece portions 20 and 21, the locked portion 4 is inserted between the locking piece portions 18 and is securely locked to the locking portion 15. Therefore, the seat cover 2 can properly be attached to the seat body 5.

In the embodiments of the present invention, when the thickness, height, width, and the like are the “same,” this includes a case where they are substantially the same.

In other embodiments of the present invention, the base portion has any shape. Therefore, for example, the base portion is square, polygonal, circular, or oval.

In another embodiment, there are any number of locking portions. Therefore, for example, the number of locking portions is at least three.

In another embodiment, the one-sided locking piece portion has the claw portion, but the elastic locking piece portion does not have the claw portion.

In another embodiment, the elastic locking piece portion has the claw portion, but the one-sided locking piece portion does not have the claw portion.

In another embodiment, the one-sided locking piece portion is not elastically deformed.

In another embodiment, the thickness of the one-sided locking piece portion and the thickness of the elastic locking piece portion are different from each other. For example, the thickness of the elastic locking piece portion is thinner than the thickness of the one-sided locking piece portion. In the present invention, since the elastic locking piece portion is more easily elastically deformed than the one-sided locking piece portion, as long as the thickness of the elastic locking piece portion is thinner than the thickness of the one-sided locking piece portion, thereby making it easier for the elastic locking piece portion to be elastically deformed, the width of the elastic locking piece portion and the width of the one-sided locking piece portion may be the same, or the width of the elastic locking piece portion may be wider than the width of the one-sided locking piece portion.

In another embodiment, the height of the one-sided locking piece portion and the height of the elastic locking piece portion are the same, relative to the base portion.

In another embodiment, the height of the elastic locking piece portion is higher than the height of the one-sided locking piece portion, relative to the base portion.

In another embodiment, respective one-sided locking piece portions of the adjacent locking portions are arranged in the same row in the longitudinal direction, and respective elastic locking piece portions are also arranged in the same row in the longitudinal direction.

The above describes the embodiments of the present invention in detail, but the present invention is not limited to the embodiments described above. The present invention allows for various design modifications as long as they do not depart from the matters described in the claims. The present invention can be used in, for example, seats in vehicles such as automobiles, trains, ships, and aircraft, as well as in indoor facilities such as theaters.

What is claimed is:

1. A clip attached to a seat body and configured to attach a seat cover covering the seat body to the seat body by locking a locked portion of the seat cover, the clip comprising:
a base portion embedded in the seat body; and
a plurality of locking portions arranged longitudinally in a length direction of the locked portion on an upper surface of the base portion and locking the locked portion, wherein
the locking portions are each composed of a pair of locking piece portions that extend upward from the upper surface and face each other, and
the locking piece portions are composed of a one-sided locking piece portion which is one of the locking piece portions, and an elastic locking piece portion which is another of the locking piece portions and is more easily elastically deformed than the one-sided locking piece portion.

2. The clip according to claim 1, wherein
respective one-sided locking piece portions of the locking portions adjacent to each other are arranged alternately in a longitudinal direction.

3. The clip according to claim 1, wherein
in a direction in which the pair of locking piece portions face each other, a thickness of the one-sided locking piece portion is same as a thickness of the elastic locking piece portion, and
in a longitudinal direction, a width of the elastic locking piece portion is shorter than a width of the one-sided locking piece portion.

4. The clip according to claim 2, wherein
in a direction in which the pair of locking piece portions face each other, a thickness of the one-sided locking piece portion is same as a thickness of the elastic locking piece portion, and
in the longitudinal direction, a width of the elastic locking piece portion is shorter than a width of the one-sided locking piece portion.

5. The clip according to claim 1, wherein
a height of the elastic locking piece portion is lower than a height of the one-sided locking piece portion, relative to the base portion.

6. The clip according to claim 2, wherein
a height of the elastic locking piece portion is lower than a height of the one-sided locking piece portion, relative to the base portion.

7. The clip according to claim 5, wherein
respective elastic locking piece portions of the locking portions adjacent to each other are arranged alternately in a longitudinal direction.

8. The clip according to claim 6, wherein
respective elastic locking piece portions of the locking portions adjacent to each other are arranged alternately in the longitudinal direction.

9. The clip according to claim 1, wherein
the locking piece portions each have an extension portion connected to the base portion and a claw portion connected to an upper end of the extension portion.

10. The clip according to claim 2, wherein
the locking piece portions each have an extension portion connected to the base portion and a claw portion connected to an upper end of the extension portion.
